(19) United States
(12) Patent Application Publication
(10) Pub. No.: US 2026/0280972 A1
(43) Pub. Date: Sep. 17, 2026

(54) Method and System for Resilience to GID Table Changes in Workloads

(71) Applicant: Clockwork Systems, Inc., Palo Alto, CA (US)

(72) Inventors: Vinay Kotikalapudi Sriram, Palo Alto, CA (US); Weiju Zheng, San Leandro, CA (US); Katherine Gioioso, Mountain View, CA (US); Yilong Geng, Menlo Park, CA (US)

(21) Appl. No.: 19/566,004

(22) Filed: Mar. 13, 2026

Related U.S. Application Data
(60) Provisional application No. 63/772,056, filed on Mar. 14, 2025.

(51) Int. Cl. H04L 41/0663; H04L 41/0604; H04L 43/12

(52) U.S. Cl. CPC H04L 41/0663; H04L 41/0627; H04L 43/12

(57) ABSTRACT

A system maintains remote direct memory access (RDMA) network connectivity despite mid-run changes to GID (global identifier) indices. The system maintains, for each NIC, a GID table mapping identifiers to index values and an internal address handle pool containing routing information. The system monitors these tables via periodic scanning or real-time detection to identify index changes and map them to the affected NIC. An address handle repairer updates the NIC's address handle pool by deleting outdated entries and generating new handles with the updated index, ensuring queue pairs used for health probes remain valid. Probe mesh results verify link and NIC liveness, and queue pairs are reconfigured with current indices to restore reliable data paths. This coordinated resilience for queue pairs prevents job crashes and sustains uninterrupted workload execution across link failures, VLAN/subnet changes, and dynamic network reconfigurations.

### CROSS REFERENCE TO RELATED APPLICATION

This application claims the benefit of U.S. Provisional Application No. 63/772,056, filed on Mar. 14, 2025, which is hereby incorporated by reference herein in its entirety for all purposes.

### TECHNICAL FIELD

This disclosure relates generally to computer networking, and in particular to maintaining continuous network connectivity in Remote Direct Memory Access (RDMA) workloads in view of changes to global identifier indices.

### BACKGROUND

In certain networked environments, a network interface card (NIC) maintains a table of global identifiers (GIDs) indexed for use in routing of network packets. The GID index table maps GID indices to GIDs. The GID index table is used for establishing connections and transmitting data between endpoints. The GID indices can change dynamically due to events such as link failures, interface resets, subnet reconfigurations, or other topology changes. When a GID index changes during workload execution, existing address handles and connection configurations, built with the old GID indices, become invalid. This can cause probes to fail, trigger false failovers, and disrupt data flows. This may lead to RDMA workload crashes. Conventional techniques typically assume a fixed GID index throughout a job, and do not provide automated recovery or reconfiguration when the GID index changes mid-run. As a result, such workloads in distributed high-speed computing environments have low resilience to such failures and as a result, low reliability and performance.

### SUMMARY

Remote Direct Memory Access (RDMA) is used in high-performance computing and data-intensive applications, allowing direct memory access from one host to another without involving the operating system kernel. Systems and methods disclosed herein operate in a networked computing environment using RDMA to ensure continuous communication despite changes in identifier index values. The system maintains, for a plurality of network interface cards (NICs), a mapping between identifiers and their corresponding identifier index values within a data structure, for example, a mapping table. For each NIC, the system maintains a set of address handles in an address handle pool. Each address handle includes a source identifier index and a destination identifier index pair that the NIC uses to transmit data packets to one or more other NICs. The system monitors the data structure to detect changes to identifier index values and detects when a identifier index assigned to a particular identifier has changed to another identifier index. In response to such detection, the system identifies the NIC associated with the particular identifier and updates the address handle pool for that NIC so that the address handles reference the other identifier index instead of the original identifier index. Once updated, the system transmits data packets from the NIC to other NICs using the updated address handle pool, thereby maintaining correct routing and uninterrupted communication.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

FIG. 1 is an exemplary system environment for maintaining network connectivity during GID index changes, according to an embodiment.

FIG. 2A shows the architecture of a NIC, such as an RNIC, according to an embodiment.

FIG. 2B shows the architecture of a host configured to interact with other hosts using RDMA, according to an embodiment.

FIG. 3 shows the system architecture of the GID table watcher module, according to an embodiment.

FIG. 4 shows the system architecture of the address handler repair module, according to an embodiment.

FIG. 5 shows the system architecture of the probe mesh module, according to an embodiment.

FIG. 6 is the overall process for maintaining network connectivity during GID changes, according to an embodiment.

FIG. 7 shows a flowchart illustrating the process for monitoring the GID table, according to an embodiment.

FIG. 8 shows a flowchart illustrating the process for monitoring the GID table, according to an embodiment.

FIG. 9 shows a flowchart illustrating the process of managing probe mesh, according to an embodiment.

FIG. 10 shows a flowchart illustrating the process of recovery based on queue pair detection, according to an embodiment.

FIG. 11 shows a flowchart illustrating the overall process of recovery in view of GID changes, according to an embodiment.

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### DETAILED DESCRIPTION

A system according to various embodiments maintains continuous operation of RDMA workloads in spite of dynamic changes to GID indices. In RDMA networks such as RDMA over Converged Ethernet (RoCE) environments, each network interface card (NIC) maintains a GID table containing multiple global identifiers (GIDs) indexed by integer identifiers. Applications such as NVIDIA Collective Communications Library (NCCL) workloads typically select a GID index at job startup and assume that the GID index will remain unchanged for the job's duration. However, GID indices may get reassigned, for example, when network links go down and come back up, when interfaces are reset, or when VLAN (virtual local area network)/subnet reconfigurations occur. In conventional systems, various issues may arise due to the assumption that the GID index will remain unchanged for the job's duration. For example, mid-run index changes can invalidate address handles used by unreliable datagram (UD) queue pairs for probe-based health checks, resulting in false liveness failures and unnecessary failovers. Workload crashes may occur if reliable connection (RC) queue pairs, used for data transfer, lose connectivity as a result of mid-run index changes and are unable to recover automatically. A GID index may be referred to herein as an identifier index or an index.

The system as disclosed maintains continuous operation of RDMA workloads in RoCE environments despite changes to GID (Global Identifier) indices during execution. The system uses a GID table watcher for monitoring each NIC's GID table for index changes in real time or at a set frequency. Upon detecting a change, the GID table watcher notifies an address handle repairer, which deletes outdated address handles referencing the old index and generates new address handles using the current index. For UD queue pairs, this ensures that outbound probes used for liveness and health checks remain accurate and prevent false failovers. For RC queue pairs, the system detects index changes through existing failure signals. The system reconfigures RC pairs to use the updated index based on corrected probe results from the UD mesh, thereby restoring connectivity.

The system provides several benefits over previous solutions. The system prevents workload crashes and communication failures regardless of the frequency or cause of GID index changes, thereby providing resilience. It operates efficiently and is agnostic to orchestration environment. The system maintains uninterrupted job progression in distributed high-performance computing systems. In conventional setups, UD queue pairs used for health checks fail when their address handles reference outdated GID indices. This results in false conclusions that a NIC or link is down, triggering unnecessary failovers and workload disruption. The system according to various embodiments updates UD queue pair address handles immediately upon detection of GID index changes, ensuring that probes remain accurate, thereby preventing costly false failover events. Furthermore, the system ensures that jobs continue execution without interruption, thereby reducing both downtime and loss of computational progress in distributed computing environments. This improves network throughput and efficiency compared to existing methods. The system also deletes outdated address handles and replaces them with new, correct address handles thereby avoiding accumulation of invalid entries in NIC memory. Conventional systems do not perform such cleanup, resulting in wasted resources and degraded NIC performance over time compared to the system as disclosed. Accordingly, system according to various embodiments offers several benefits compared to conventional systems, such as improving connectivity resilience, reducing false fails, preventing crashes, and ensuring continuous high-performance operation.

### System Environment

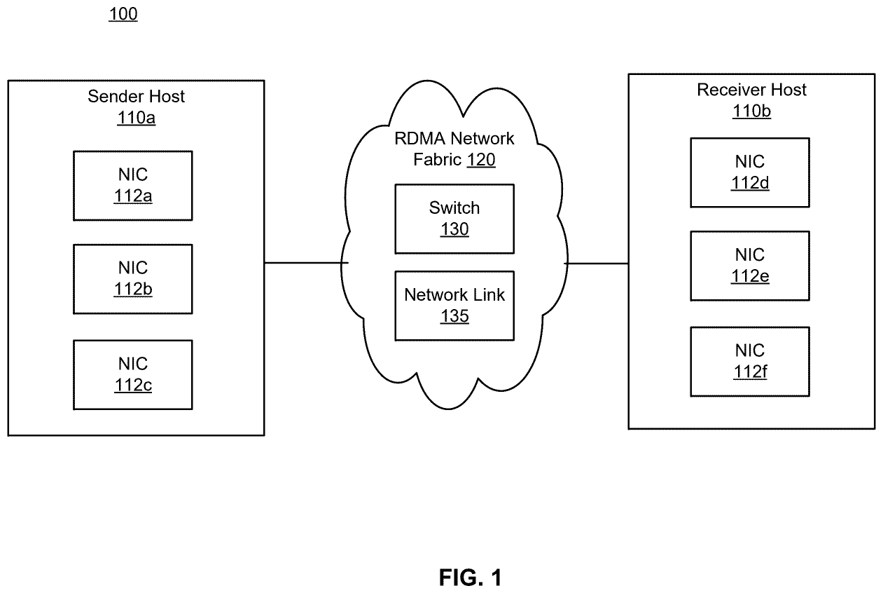

FIG. 1 is an exemplary system environment for maintaining network connectivity during GID index changes, according to an embodiment. As depicted in FIG. 1, the system environment 100 includes sender host 110a, RDMA network fabric 120, and receiver host 110b. While only one of each of sender host 110a and receiver host 110b is depicted, this is merely for convenience and ease of depiction, and any number of sender hosts and receiver hosts may be part of the system environment 100. The system environment 100 enables continuous workload operation despite GID index changes. The system achieves this by performing a combination of proactive monitoring in the sender host, adaptive repairs to address handles, responsive health probes, and coordinated data recovery in the receiver host.

The sender host 110a is a computing system that participates in RDMA communication by transmitting data packets to one or more other hosts. It contains one or more network interface cards (NICs) 112, for example, RDMA Network Interface Cards (RNICs), each with an internal GID table storing multiple GIDs indexed by GID indices, and an address handle pool containing address handles used for packet routing. The sender host further includes a module to monitor the GID table for index changes and to update affected address handles when a GID index changes. The sender host may also include modules to manage UD queue pairs for liveness checks, ensuring continued health monitoring of RDMA links despite index changes.

The receiver host 110b is another computing system equipped with one or more NICs that receive RDMA packets from the sender host. Like the sender host, each NIC maintains its own GID table and address handle pool for communication. The receiver host 110b participates in both data transfer via RC queue pairs and health probing via UD queue pairs. When the sender host 110a updates its GID index and address handles, the receiver host 110b NICs use the correct updated identifiers to maintain valid communication paths and avoid packet loss.

The RDMA network fabric 120 interconnects hosts equipped with RDMA-capable network interface cards (RNICs). The RDMA network fabric 120 provides low-latency, kernel-bypass communication over protocols such as RDMA over Converged Ethernet (ROCE) or InfiniBand. The RDMA network fabric 120 comprises both physical and logical components that work together to deliver end-to-end transport and routing for RDMA traffic. Physical elements include switches 130, for example, top-of-rack (ToR) switches that provide rack-level connectivity, intermediate switches and routers linking ToR switches, aggregation/core switches for interconnecting multiple racks. Physical elements also include links 135, for example, copper or optical network links and ports connecting NICs to switches and switches to each other.

The RDMA network fabric 120 may be deployed in large-scale topologies such as a FAT tree to provide high-bandwidth, low-latency interconnections. The RDMA network fabric 120 includes logical elements such as the RDMA transport layer, VLAN and subnet configurations, RDMA routing and path records, and network management systems or subnet managers. The RDMA transport layer (e.g., RoCE, InfiniBand, and the like) provides the protocol for direct memory access between hosts without OS kernel involvement. The VLAN and subnet configurations provide logical segmentation, traffic isolation, and routing control. The network management systems or subnet managers coordinate GID assignments, distribute GID index values, and manage routing updates. RDMA routing/path maintains records that determine how packets are delivered to specific GIDs. Network management systems and subnet managers are responsible for coordinating GID assignments, distributing index values, and orchestrating routing updates.

The RDMA network fabric 120 is the environment in which events such as link failures, link flaps, interface resets, VLAN changes, and subnet reconfigurations occur. These events may involve network resource reallocation or identifier mapping changes and can cause the GID index stored in an NIC's GID table to change during runtime. Because GID indices are directly referenced by RDMA components, such changes can disrupt packet routing and connection integrity unless addressed by the resilience mechanisms described herein, which detect mid-run GID index changes, update address handles, and reconfigure queue pairs to maintain uninterrupted RDMA communications.

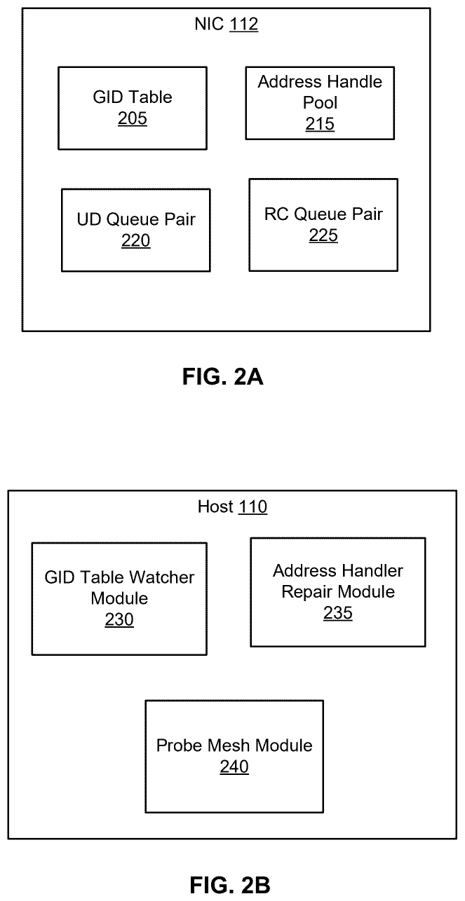

The detailed architecture of a host 110 is provided in FIGS. 2A-2B. FIG. 1 and the other figures use like reference numerals to identify like elements. A letter after a reference numeral, such as “105A,” indicates that the text refers specifically to the element having that particular reference numeral. A reference numeral in the text without a following letter, such as “105,” refers to any or all of the elements in the figures bearing that reference numeral (e.g. “105” in the text refers to reference numerals “105A” and/or “105N” in the figures).

### System Architecture

FIG. 2A shows the architecture of a NIC, such as an RNIC (RDMA NIC), according to an embodiment. As depicted in FIG. 2A, an NIC 112 includes a GID table 205, an address handle pool 215, one or more UD queue pairs 220, and one or more RC queue pairs 225. A NIC 112 is responsible for enabling high-performance, low-latency data transfer in an RDMA environment by interfacing directly with the RDMA network fabric 120 and maintaining internal data structures and communication endpoints. In various embodiments, the NIC 112 may be implemented as an RDMA-capable network interface card (RNIC) configured to bypass the host operating system's kernel during data transmission, thereby reducing latency and improving throughput. The NIC 112 integrates several specialized components, including a GID table 205, an address handle pool 215, one or more UD queue pairs 220, and one or more RC queue pairs 225, each serving distinct roles in maintaining connectivity and ensuring proper packet routing.

The GID table 205 functions as an internal data structure within the NIC 112 that stores multiple global identifiers (gids), each associated with a unique GID index. In one embodiment, the GID table is based on the ipv6 address format and enables the NIC to support multiple network identities, VLANs, or subnets. The GID table 205 is referenced during the establishment of RDMA connections and when constructing packet headers to ensure accurate addressing. In some embodiments, the GID table may be dynamically updated in response to network events such as link failures, VLAN reconfiguration, or subnet changes. The GID table interacts closely with other modules, such as monitoring components on the host, to detect index changes and propagate updates to connection-related data structures.

The address handle pool 215 is a memory region within the NIC 112 holding address handles used for packet transmission. Each address handle contains routing information including a source GID index, destination GID, and other parameters required for establishing an RDMA path. In various embodiments, the address handle pool may maintain handles for both UD and RC communication, though UD queue pairs are most commonly associated with address handles due to their dynamic probe-based connectivity checks. The address handle pool 215 interacts with external repair processes that delete outdated handles and create new ones when the GID index changes, ensuring continuity of communication.

The UD queue pairs 220 represent unreliable datagram communication endpoints within the NIC 112. They are used for lightweight, connectionless packet transmission, often in the form of health-check probes to verify link and NIC liveness. In certain embodiments, UD queue pairs operate in conjunction with a probe mesh controller to send and receive periodic probes, providing real-time connectivity status. The UD queue pairs 220 rely on correct address handles from the address handle pool 215, and any change to the GID table 205 may require re-binding to updated handles.

The RC queue pairs 225 are reliable connection endpoints within the NIC 112, configured for sustained data transfer once a connection is established. In one embodiment, RC queue pairs are used for the main data path in workloads such as distributed training or high-performance computing tasks. These queue pairs require a consistent GID index during setup; however, in some embodiments, they can be reconfigured at runtime if a GID index changes. The RC queue pairs 225 may detect failures through timeouts or error signals and interface with higher-level recovery procedures, which may query the probe mesh maintained by UD queue pairs 220 to obtain updated connection parameters.

In summary, the NIC 112 combines the GID table 205, address handle pool 215, UD queue pairs 220, and RC queue pairs 225 into a cohesive architecture that supports both reliable and unreliable RDMA communications. The interactions between these components enable dynamic adaptation to network changes while maintaining high performance and connectivity across the RDMA network fabric.

FIG. 2B shows the architecture of a host configured to interact with other hosts using RDMA, according to an embodiment. As depicted in FIG. 2B, the host 110 includes a GID table watcher module 230, and address handler repair module 235, and a probe mesh module 240. The host may include other components, for example, NICs such as RNICs as shown in FIG. 1.

The GID table watcher module 230 is configured to monitor the GID table of each network interface card (NIC) within the host to detect changes in GID index values. Its overall functionality is to ensure that any mid-run change to the GID index, which could otherwise disrupt RDMA communication, is promptly detected and acted upon. In various embodiments, the GID table watcher operates as a lightweight monitoring thread running continuously alongside the workload processes. The module may periodically scan the GID tables at a predetermined interval or subscribe to event-driven notifications from the NIC driver to capture updates in real time. Upon detection of a change, the GID table watcher module identifies the particular NIC associated with the modified GID index and generates a change notification for other modules in the host. This module interacts closely with the address handle repair module 235, providing it with the necessary context to perform targeted repairs. In some embodiments, the watcher can be configured to monitor additional identifier parameters beyond GID index values, enabling broader resilience to network configuration changes.

The address handle repair module 235 is responsible for maintaining valid routing information within each NIC's address handle pool when GID index changes occur. Its primary function is to respond to notifications from the GID table watcher module 230 by identifying address handles that reference the outdated GID index and replacing them with updated handles that match the current index. In various embodiments, the module performs a multi-stage process that includes searching the address handle pool for affected entries, deleting obsolete handles, creating new handles with the correct GID index and destination GID, and storing them back into the pool. The address handle repair module 235 ensures that outbound packets, particularly those sent using UD queue pairs, are correctly addressed so that they reach the intended destination. This module may incorporate verification routines to test new handles before use, and in some implementations, can manage pools for both UD and RC queue pairs, although its primary role is in supporting UD probe traffic.

The probe mesh module 240 is designed to manage the health-monitoring and connectivity verification functions within the host using UD queue pairs. Its overall functionality is to construct, transmit, and receive probe packets between NICs to assess network liveness and link health. In various embodiments, the probe mesh module schedules probe transmissions periodically or adaptively based on observed network conditions, constructs probe packets using the latest address handles provided by the address handle repair module 235, and parses responses to determine connectivity status. The module's connectivity analysis can detect link failures, degraded performance, or changes in network topology. Probe results are shared with other modules, such as RC queue pair management processes, which may need to reconfigure data paths based on the current network state. The probe mesh module 240 interacts directly with UD queue pairs in each NIC and, through integration with the GID table watcher and address handle repair modules, ensures that probes remain valid even when GID indices change mid-run. In some embodiments, the module can incorporate latency measurement and fault isolation functionality to assist in broader network diagnostics.

In one embodiment, the implementation of the disclosed modules is accomplished through a software agent, which may be downloaded and installed on any third-party sender or receiver host that participates in RDMA workloads. The agent may execute as a user-space service or daemon and has the necessary privileges to interact with host-resident RDMA network interface cards (NICs), for example, RDMA Network Interface Cards (RNICs), through NIC driver APIs and RDMA verbs libraries. Upon installation, the agent instantiates the functional modules depicted in FIG. 2B, including the GID table watcher module 230, address handle repair module 235, and probe mesh module 240, as software components such as concurrent threads, microservices, or executable processes. These modules perform continuous monitoring, repair, and probe-based verification functions directly on the host while coordinating with the underlying RDMA stack. The agent may operate in an autonomous mode on the host system or communicate with an optional centralized server for configuration distribution, telemetry reporting, and lifecycle management. Accordingly, the modules shown in FIG. 2B constitute software components supplied and controlled by a server, executing on a third-party host without requiring hardware modification or NIC firmware changes.

In one embodiment, the components shown in FIG. 2A, including the GID Table 205, address handle pool 215, UD queue pairs 220, and RC queue pairs 225, correspond to data structures and communication endpoints native to RDMA NICs rather than proprietary hardware. The agent interfaces with these elements through driver-level APIs, such as those provided by an operating system library or other vendor libraries, and maintains software-resident metadata structures that mirror NIC-resident state. Through these mirrored data structures, the agent continuously monitors GID table changes, detects index reassignment events, and initiates repair of affected address handles residing in the NIC memory. In one embodiment, the agent may optionally install a kernel plugin or user-space driver extension that subscribes to NIC driver notifications. This enables real-time detection of GID index changes and instantaneous triggering of the address handle repair and probe mesh routines. Accordingly, the components shown in FIG. 2A may be standardized RDMA data structures accessed by the system that operates through externally deployed logic on the host system. This eliminates dependencies on specific NIC vendors or hardware modifications.

In another embodiment, the agent may be configured to communicate securely with a centralized server, which may reside in the cloud, an enterprise data center, or an on-premises management system. In this configuration, the server distributes operational parameters to deployed agents, including monitoring frequency, automatic repair thresholds, and probe scheduling intervals. The agents stream telemetry data, performance logs, and detected GID index change events back to the server for aggregated analysis and centralized control. The server can coordinate resilience management across multiple senders and receivers, providing large-scale orchestration, policy enforcement, and update propagation. According to this embodiment, the functionality disclosed herein is deployed as a service, where each third-party host remains independent and benefits from globally optimized coordination maintained by the server.

In another embodiment, the agent may be packaged as a containerized module or sidecar process and deployed alongside RDMA-based applications within an orchestration system such as Kubernetes, Slurm, or other cloud and HPC environments. When launched, the container detects all RDMA-capable NIC interfaces available on the host, loads the components such as the GID table watcher module 230, address handle repair module 235, and probe mesh module 240, and interacts with the NIC driver endpoints via interfaces. This configuration simplifies deployment on heterogeneous infrastructure, providing uniform behavior at scale across multiple hosts. The containerized agent continuously monitors NIC-resident GID tables, performs address handle repair upon index change detection, and maintains connectivity through probes. This embodiment allows consistent implementation of the functionality across environments with diverse administrative controls such as virtual machines, containers, or bare-metal systems.

Across embodiments, the modules shown in FIG. 2A-2B may be deployed through explicit installation of software onto third-party sender and receiver hosts that participate in RDMA communication. The agent installs through standard package delivery or container distribution and runs in user-space with sufficient privileges to access RDMA driver APIs, while leaving NIC firmware unmodified. At runtime, the agent spawns and manages the GID table watcher module 230, address handle repair module 235, and probe mesh module 240 as concurrent threads or services that actively monitor and update the NIC data structures of FIG. 2A. The agent may optionally synchronize with a centralized server for orchestration and reporting but can also function independently to ensure resilience at the host level. The system thereby enables practical deployment of all modules and data structures described herein on third-party hosts.

In one embodiment, a central coordinator performs the monitoring and updating functions rather than the local host 110. The coordinator maintains a global data structure containing GID index mappings for a plurality of NICs across different hosts. It monitors network-wide GID tables, detects index changes, and issues update instructions to the affected hosts over a management channel. When a GID index change is detected, the coordinator identifies the associated NIC and transmits a directive to the corresponding agent on the host, instructing it to update its local address handle pool accordingly. After update confirmation, the server can validate health by initiating probe traffic or command execution through the host's probe mesh module. This embodiment provides centralized operation various steps, while the hosts act on commands received. Accordingly, the system supports deployment where monitoring and repair occur remotely in a management plane separate from RDMA network fabric 120.

In a further embodiment, the monitoring and updating functions are distributed among multiple hosts equipped with agents that cooperate. Each agent maintains its own local mapping of GID indices and address handles for the NICs under its control and exchanges periodic synchronization messages with other agents or a server to build a shared global view. Upon detecting a GID index change on one host, the detecting agent sends a notification to all peer agents, enabling them to update any relevant address handle pools that reference the changed index. This embodiment provides decentralized resilience where monitoring, detection, repair, and probe validation are executed by a collective of actors rather than a single host. Each actor may perform any subset of the operations, for example, monitoring and detection within one agent, and address-handle rebuilding and data-packet transmission in another. This distributed configuration enables scalability for large RDMA clusters.

In another embodiment, the system is deployed in a hybrid fashion where the server performs high-level monitoring and analysis, while individual hosts perform low-level update and transmission operations. The coordinator periodically collects GID table snapshots from hosts to build a topology map and detect inconsistencies or index reassignments. When the server identifies changes, it sends concise update packets to affected hosts directing the address handle repair module 235 to regenerate handles using current indices. Concurrently, hosts may continue local monitoring and autonomous repairs, ensuring redundancy. Accordingly, the various actions can be executed partly by a central actor and partly by distributed hosts.

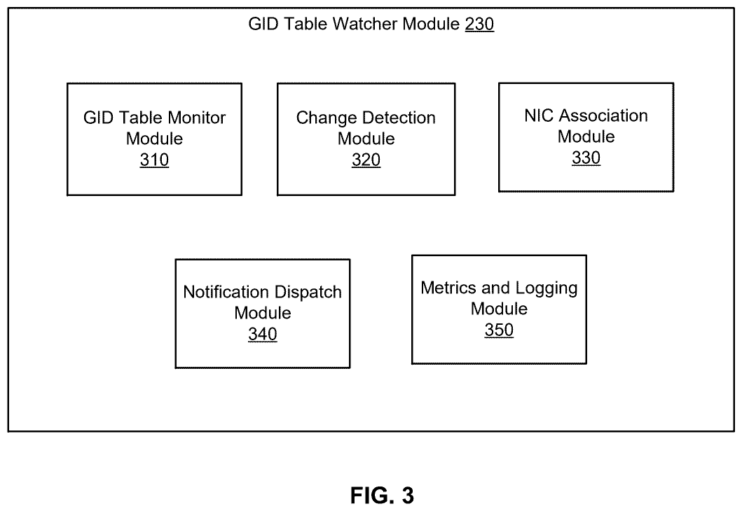

FIG. 3 shows the system architecture of the GID table watcher module, according to an embodiment. The GID table watcher module 230, as shown in FIG. 3, includes a GID table monitor module 310, a change detection module 320, a NIC association module 330, a notification dispatch module 340, and a metrics and logging module 350. The GID table monitor module 310 is configured to observe the GID table of each NIC to identify any variations in stored GID index values. The change detection module 320 processes monitored data to determine when a GID index has changed and the nature of that change. The NIC association module 330 maps a detected GID index change to the corresponding NIC that is affected in the host system. The notification dispatch module 340 generates and sends change events to other host modules, enabling timely corrective actions. The metrics and logging module 350 records detected changes, dispatched notifications, and related operational data for performance monitoring and troubleshooting.

The GID table monitor module 310 is configured to observe the GID table of each network interface card (NIC) within the host to identify changes in GID index values. Its overall functionality is to provide a continuous or periodic view of the GID table state so that any modifications to the mapping between GIDs and their indices can be promptly detected. In various embodiments, this module may be implemented as a polling process with a fixed interval, an event-driven listener that subscribes to NIC driver callbacks, or a hybrid system combining periodic checks with on-demand triggers. The GID table monitor module 310 interacts closely with the change detection module 320 by delivering current GID table data for comparison against baseline or historical values.

The change detection module 320 is responsible for analyzing the data provided by the GID table monitor module 310 to determine when a GID index has been altered. Its primary function is to differentiate between transient or invalid states and legitimate index changes that require corrective action. In various embodiments, this module may implement comparison logic using stored snapshots of prior GID table states, delta analysis techniques to detect modifications, or pattern recognition algorithms that identify repeated changes indicative of instability. The change detection module 320 communicates with the NIC association module 330 to pass information about verified changes along with the associated identifier details.

The NIC association module 330 maps detected GID index changes to the specific NIC affected in the host system. Its overall functionality is to determine which network interface should be subject to subsequent repair actions. In various embodiments, this mapping may be facilitated by maintaining a registry of all NICs and their current GID indices, by querying the NIC's hardware configuration directly, or by using higher-level network configuration data. The NIC association module 330 interacts with the notification dispatch module 340 to initiate downstream responses and with other host modules such as the address handle repair module to ensure corrective measures are targeted appropriately.

The notification dispatch module 340 generates and sends change events to other modules in the host system or to external orchestration systems. Its overall role is to act as a trigger mechanism that informs dependent components about GID index changes so they can perform necessary updates. In various embodiments, notifications may be sent via inter-process communication channels, message queues, API calls, or network-based signaling to external management systems. The notification dispatch module 340 typically interfaces with the address handle repair module and the probe mesh module to coordinate immediate repair and health-check operations, ensuring minimal disruption to active workloads.

The metrics and logging module 350 records detected changes, dispatched notifications, and related operational data for performance monitoring and troubleshooting. Its functionality includes generating logs for audit purposes, capturing metrics to evaluate the frequency and impact of GID index changes, and storing these records in persistent databases or telemetry systems. In various embodiments, the module may implement configurable verbosity levels, structured logging formats, and integration with monitoring dashboards or analytics tools. The metrics and logging module 350 interacts with other modules in the GID table watcher module 230 by receiving information about events, decisions, and actions, providing a historical record that can be used for diagnostics, optimization, and compliance reporting.

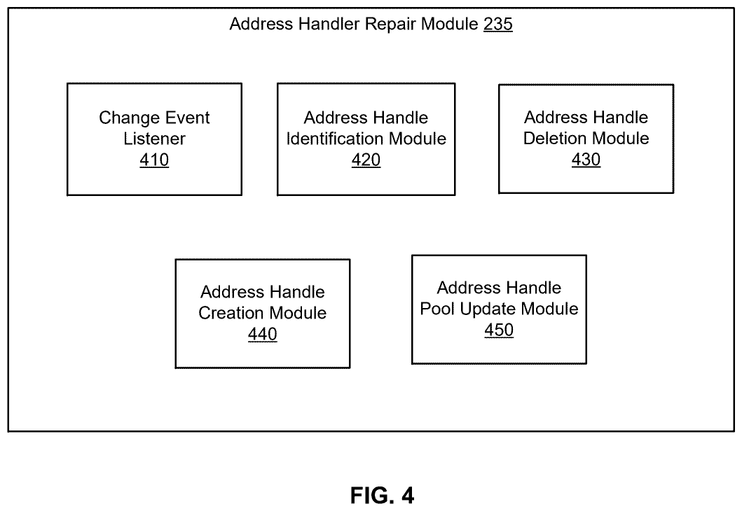

FIG. 4 shows the system architecture of the address handler repair module 235, according to an embodiment. The address handler repair module 235, as shown in FIG. 4, includes a change event listener 410, an address handle identification module 420, an address handle deletion module 430, an address handle creation module 440, and an address handle pool update module 450. The change event listener 410 is configured to receive notifications from the GID table watcher module when a GID index change is detected for a particular NIC. The address handle identification module 420 locates all address handles in the affected NIC's address handle pool that reference the outdated GID index. The address handle deletion module 430 removes the identified outdated address handles from the address handle pool to prevent incorrect packet routing. The address handle creation module 440 generates new address handles that reference the updated GID index and contain the correct destination addressing information. The address handle pool update module 450 stores the newly created address handles in the corresponding NIC's address handle pool and makes them available for use by queue pairs in ongoing RDMA communication.

The change event listener 410 is configured to receive notifications from the GID table watcher module when a GID index associated with a particular NIC has changed. Its overall functionality is to act as the trigger point for initiating the address handle repair process whenever a change is detected. In various embodiments, the change event listener may be implemented using inter-process communication channels, message queues, driver-level callbacks, or event subscription mechanisms.

The address handle identification module 420 is responsible for locating all address handles in the affected NIC's address handle pool that reference the outdated GID index. Its overall function is to isolate the subset of address handles that require replacement due to index changes. In various embodiments, this module may maintain a searchable index of address handles keyed by GID index, perform sequential scans of the address handle pool, or use hash-based lookups to efficiently identify relevant entries. The identification module interacts with the address handle deletion module 430 by passing the list of obsolete handles that must be removed and may also provide filtered datasets to the address handle creation module 440 for generating replacements.

The address handle deletion module 430 is configured to remove outdated address handles from the address handle pool to prevent incorrect packet routing. Its overall functionality is to ensure that no handle referencing the old GID index remains in the NIC's memory space, thereby avoiding transmission errors. In various embodiments, deletion May involve explicit deallocation of NIC memory structures, issuing driver-level commands to invalidate handles, or marking entries as inactive for eventual garbage collection.

The address handle creation module 440 is tasked with generating new address handles that reference the updated GID index and contain correct destination GID information. Its overall functionality is to rebuild routing structures that enable the NIC to send packets using the new index. In various embodiments, creation may involve calling NIC firmware APIs, constructing handle data structures in host memory before transferring to NIC memory, or using templated configurations for rapid provisioning. This module interacts with the address handle pool update module 450 to supply freshly created handles and may integrate with external configuration databases or workload orchestration systems to ensure correct destination mapping.

The address handle pool update module 450 is responsible for storing the newly created address handles in the NIC's address handle pool and making them immediately available for use by UD queue pairs or other relevant communication endpoints. Its overall functionality is to finalize the repair process by replacing obsolete entries with updated handles, thereby restoring connectivity. In various embodiments, this module may write directly to NIC-managed memory regions, update internal pool indices, or perform validation routines to confirm handle correctness before activation. The address handle pool update module 450 interacts with queue pair management subsystems to ensure that outbound probes and other communications are bound to valid address handles, enabling seamless operation after GID index changes.

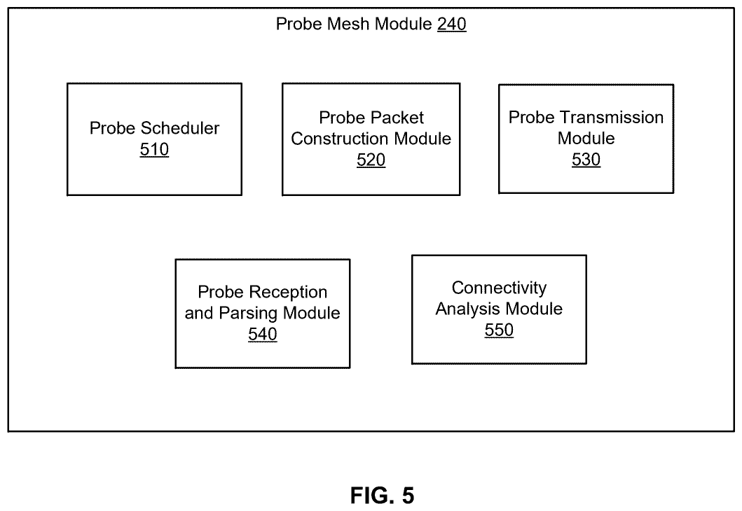

FIG. 5 shows the system architecture of the probe mesh module 240, according to an embodiment. The probe mesh module 240, as shown in FIG. 5, includes a probe scheduler 510, a probe packet construction module 520, a probe transmission module 530, a probe reception and parsing module 540, and a connectivity analysis module 550. Other embodiments may include more, fewer, or different modules.

The probe scheduler 510 determines the timing and frequency for transmitting probe packets used to assess network connectivity and link health. The probe scheduler 510 ensures that probes are sent at intervals that balance responsiveness with minimal overhead on system resources. The probe scheduler 510 may send probe packets at fixed periodic intervals. Alternately, the probe scheduler 510 may dynamically adjust probe frequency based on recent network performance or responding to specific triggers such as detection of link issues or GID index changes.

The probe packet construction module 520 generates probe packets that include the destination addressing and any necessary metadata to perform effective connectivity verification. The probe packet construction module 520 creates packets suitable for transmission over UD queue pairs, ensuring that each probe is correctly addressed using updated address handles in the event of GID index changes. The probe packet construction module 520 may assemble probe packets in host memory before transferring them to NIC memory. The assembled probe packet may include diagnostic information such as timestamps, or payloads for latency measurement.

The probe transmission module 530 sends probe packets to designated remote NICs using appropriate UD queue pairs. The probe transmission module 530 ensures that probes are dispatched and reach their intended destinations. The probe transmission module 530 may implement probe transmission via driver-level API calls or via RDMA communication libraries.

The probe reception and parsing module 540 is responsible for receiving probe responses from remote NICs and extracting relevant connectivity and performance information. Its overall functionality is to interpret probe return data to determine whether the target NIC and associated network link are operational. In various embodiments, parsing may include verifying source and destination identifiers, checking for match with expected GID index values, measuring response latency, and detecting anomalies such as packet loss or corruption.

The connectivity analysis module 550 analyzes the probe results to assess NIC and link health, detect failures, and generate status information for other system modules. The connectivity analysis module 550 transforms probe data into actionable insights for failure recovery and network optimization. The connectivity analysis module 550 may perform connectivity analysis using threshold-based decision logic or models to predict impending failures.

### Processes

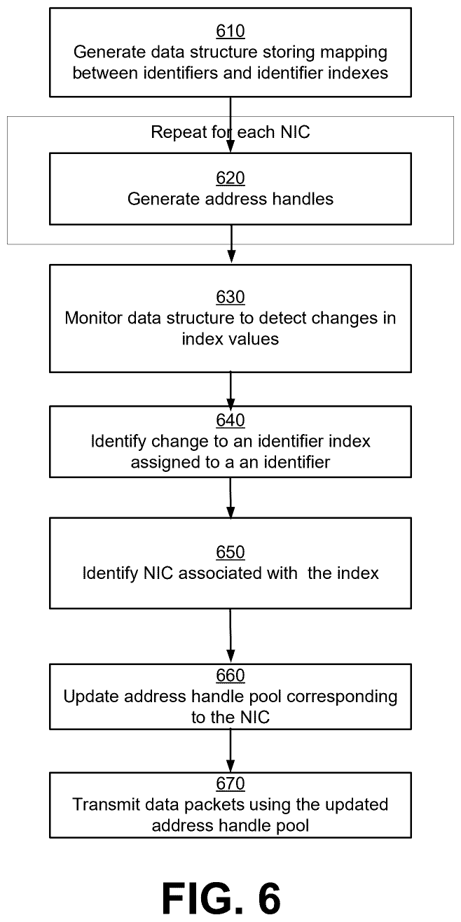

FIGS. 6-11 are various processes executed by the system as disclosed. The steps of the processes may be executed by the modules disclosed in FIGS. 1-5. The steps may be performed in an order different from that indicated in the flowcharts. For example, certain steps may be performed in parallel with other steps of the process.

FIG. 6 is the overall process for maintaining network connectivity during GID changes, according to an embodiment.

The GID table watcher module 230 generates 610 a data structure storing a mapping between identifiers and identifier index values for a plurality of network interface cards (NICs). In one embodiment, the identifiers are global identifiers (gids) for RDMA communication and the index values are GID indices stored in a GID table maintained within each NIC. The GID table watcher module 230 may populate this mapping by querying firmware-level GID table entries through driver APIs, or by reading cached GID configurations from system memory.

The address handle repair module 235 generates 620 address handles for each NIC of the plurality of NICs. In one embodiment, each address handle includes a source identifier index corresponding to the NIC's local GID index and a destination identifier index corresponding to the target NIC. This generation may involve issuing RDMA verbs to allocate address handle objects into NIC memory and binding them to UD queue pairs for probe traffic or RC queue pairs for data traffic. The address handle repair module 235 may pre-generate handles for all known destinations and store them in an address handle pool to reduce latency when new connections are required.

The GID table watcher module 230 monitors 630 the data structure to detect changes in index values. In one implementation, this monitoring is performed by a low-overhead thread that periodically polls NIC GID tables at user-configured intervals and compares them against a stored baseline. In another embodiment, the watcher may use event-driven monitoring by registering callbacks with the NIC driver so that any GID table change triggers immediate evaluation. The monitoring can also be extended to track additional parameters such as VLAN id or subnet id when broader connection resilience is required.

The change detection module 320 detects 640 a change to an identifier index assigned to an identifier. In one embodiment, this involves comparing current GID index entries from the latest GID table snapshot against historical entries in the mapping data structure to identify mismatches. The change detection module 320 detects 640 may classify changes as transient or permanent based on repeated polling results to avoid false positives due to temporary read inconsistencies.

The NIC association module 330 identifies 650 a NIC associated with the particular index that has changed. In one embodiment, the association is performed by matching the changed GID index to the NIC's hardware port identifier within the mapping data structure. This may include multi-NIC host configurations where several NICs are monitored simultaneously. The NIC association module 330 may determine the association via the subnet manager or a central network configuration registry.

The address handle repair module 235 updates 660 the address handle pool corresponding to the identified NIC. In one embodiment, the module locates all address handles in the NIC's pool that reference the outdated GID index, deletes them, and generates new address handles referencing the updated index. This update may be executed as an atomic operation within NIC memory to avoid routing disruptions during the handle replacement. The update process may retain unaffected handles to minimize rebuild overhead or may regenerate the entire pool if network topology has significantly changed.

The probe mesh module 240 transmits 670 data packets using the updated address handle pool from the NIC to one or more other NICs. The probe mesh module 240 may send outbound probes via UD queue pairs to verify link and NIC liveness using the newly updated address handles. These probe packets confirm that packets reach the correct destinations and that responses are received, ensuring the validity of the updated routing information. The probe mesh module 240 may send operational workload data via RC queue pairs using the updated address handles, restoring reliable communication for main application traffic. The transmission step can include fallback mechanisms to select alternative NICs or routes if updated handles still encounter connectivity issues.

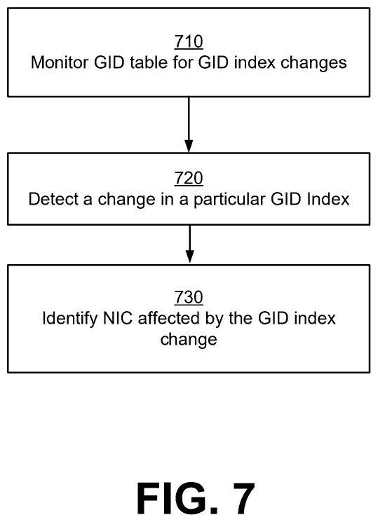

FIG. 7 shows a flowchart illustrating the process for monitoring the GID table, according to an embodiment. The system monitors each NIC's GID table to identify any changes in the GID index values through periodic scanning, at a predetermined interval or through real-time detection using event-based notifications from the NIC driver. Once a change is detected, the system determines whether the alteration involves the GID index alone or the GID value itself. The detected change is mapped to the specific NIC affected, ensuring that subsequent corrective actions, such as address handle updates, are precisely targeted. The steps are described in detail as follows.

The GID table watcher module 230 monitors 710 the GID table for GID index changes. The overall functionality of this step is to continuously or periodically observe the GID table maintained by each NIC in the host to determine whether any GID index values have been altered. In various embodiments, the module may perform this monitoring through periodic polling, subscribing to event notifications from the NIC driver, or combining both methods to balance responsiveness and resource efficiency. This monitoring provides the input signal for subsequent change detection and repair operations.

The change detection module 320 detects 720 a change in a particular GID index by examining the current GID table data provided by the GID table watcher module 230 and identifying deviations from the last known state. In one embodiment, the change detection module 320 compares stored baseline values against live readings to determine when an index has changed. In another embodiment, the change detection module 320 calculates deltas between successive readings to highlight differences. The change detection module 320 filters out transient inconsistencies to avoid triggering unnecessary repairs and ensures only validated changes proceed to the next step.

The NIC association module 330 identifies 730 a NIC affected by the GID index change. The NIC association module 330 maps the changed GID index to the particular network interface card within the host that owns it. This may be performed by matching hardware port identifiers, querying NIC configuration data, or referencing internal mappings maintained during system initialization.

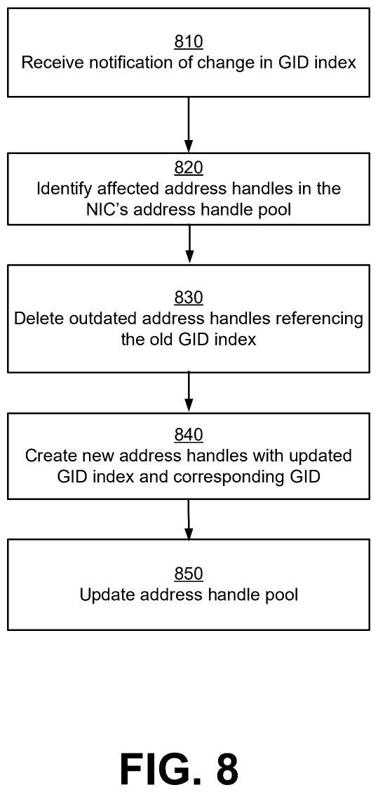

FIG. 8 shows a flowchart illustrating the process for monitoring the GID table, according to an embodiment. The process is performed by the address handle repair module 235 to maintain valid routing for UD queue pairs in response to changes in a NIC's GID index. This process ensures that outbound probes and other UD queue pair communications continue to function correctly by replacing outdated address handles with new ones that reference the updated GID index. When a GID table change is detected by the GID table watcher module 230, the repair process is triggered to target only the affected NIC and perform timely updates to its address handle pool, thereby preventing packet loss and maintaining continuous connectivity.

The change event listener 410 receives 810 a notification of change in GID index from the GID table watcher module 230. The notification may be delivered via an inter-process communication channel or a callback invoked by the watcher upon detecting an index update. In alternative embodiments, message queues or signaling mechanisms integrated with the NIC driver may be used to trigger this step. The listener ensures that only verified change events initiate the repair process, avoiding unnecessary disruption.

The address handle identification module 420 identifies 820 affected address handles in the NIC's address handle pool that reference the outdated GID index. The address handle identification module 420 may identify affected handles by using indexed lookups keyed by source GID index, a linear scan of the pool's entries, or by filtering based on metadata associated with each handle. In some embodiments, the address handle identification module 420 excludes handles bound to unaffected destinations, reducing the scope of subsequent deletion and creation steps.

The address handle deletion module 430 deletes 830 outdated address handles in the address handle pool that reference the old GID index. This removal may involve explicit deallocation of NIC memory objects, issuing invalidation commands via RDMA verbs, or marking handles as inactive for later cleanup. Ensuring complete removal of stale handles prevents packets from being routed using incorrect index values, which could cause failures in probe delivery.

The address handle creation module 440 creates 840 new address handles with the updated GID index and corresponding destination GID. The creation process may involve building handle structures in host memory before transferring them to NIC memory, or directly invoking NIC firmware APIs to allocate and configure the new handles.

The address handle pool update module 450 updates 850 the address handle pool with the new handles so that UD queue pairs immediately use valid routing data. This update may be performed atomically to prevent race conditions with ongoing transmissions, or may be staged in a way that allows gradual replacement of invalid handles. Once updated, UDQPs can resume probe transmission and response handling without interruption, ensuring accurate liveness detection and sustained RDMA communication paths.

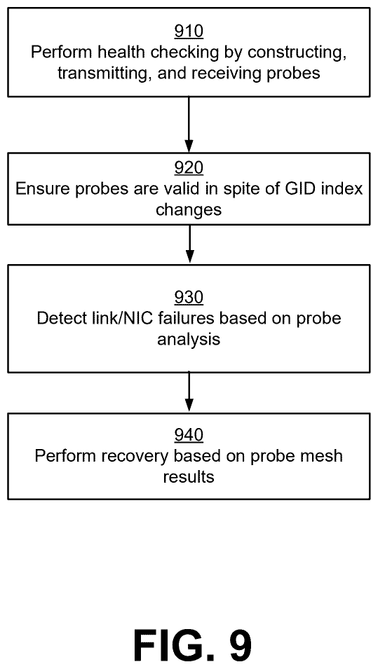

FIG. 9 shows a flowchart illustrating the process of managing probe mesh, according to an embodiment. The probe mesh module 240 maintains accurate NIC and link health information within an RDMA environment. The probe mesh module 240 uses UD queue pair based probes to perform liveness detection, failure identification, and recovery coordination. The probe mesh module 240 operates in conjunction with updated address handles generated following GID index changes to ensure that probe packets remain valid and reach their intended destinations. By constructing, transmitting, and receiving probe packets, analyzing probe responses, and integrating the results with RC queue pair recovery workflows, the probe mesh module 240 maintains workload connectivity and recovery from failures without interruption.

The probe mesh module 240 performs 910 health checking by constructing, transmitting, and receiving probes over UD queue pairs. The probe mesh module 240 may construct probes by assembling packets that include the correct source GID index and destination GID obtained from the updated address handle pool. Transmission may be triggered periodically based on the probe scheduler or adaptively in response to suspected link degradation, while reception and parsing validate probe responses for accuracy and completeness. The probe mesh module 240 may add diagnostic payloads to probes for latency measurement or packet integrity verification.

The probe mesh module 240 ensures 920 probes are valid in spite of GID index changes by integrating updated address handles from the address handle repair module 235. This step binds outbound probes to correct routing information so that they traverse valid paths to the target NICs. In various embodiments, the integration may involve dynamically rebinding UD queue pairs to new address handles immediately after repair completion, or maintaining a rolling update strategy to reduce transmission disruption.

The connectivity analysis module 550 detects 930 link/NIC failures based on probe analysis. This involves evaluating probe response data to determine whether the target NIC or the path is operational. For example, repeated probe failures with no responses may indicate a link outage, while delayed responses may signal congestion or partial failure. In other embodiments, this detection 930 may incorporate statistical modeling, historical probe data comparison, or correlation with network management alerts for higher accuracy.

The connectivity analysis module 550 performs 940 recovery based on probe mesh results. The connectivity analysis module 550 may user the probe-derived connectivity map to inform RC queue pair recovery workflows by identifying which NICs are alive and their current GID indices. In one embodiment, the connectivity analysis module 550 triggers RC queue pair reconfiguration to use a valid GID index and bypass failed links. The connectivity analysis module 550 may initiate failover to backup NICs or reroute traffic through alternate network paths. By integrating probe mesh insights, the system restores reliable communication and sustains workload execution after link or NIC failures.

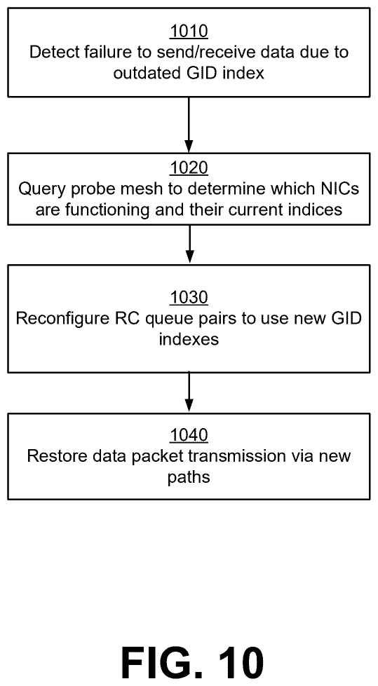

FIG. 10 shows a flowchart illustrating the process of recovery based on queue pair detection, according to an embodiment. The process shows the RC queue pair detection and recovery workflow, which is designed to maintain reliable RDMA communication in the event of a GID index change. The system uses RC queue pairs for sustained, reliable data transfer. The operation of RC queue pairs depends on consistent configuration of the local GID index. When a GID index changes mid-run, packets can no longer be sent or received reliably unless corrective actions are taken. This process detects failures caused by outdated GID indices, obtains current index information from the probe mesh, and reconfigures RC queue pairs to restore the data path, thereby allowing workloads to continue without interruption.

The host 110 detects 1010 an inability to send or receive data due to an outdated GID index. In one embodiment, this detection is performed by monitoring for transmission timeouts, absence of completion notifications, or receipt of error signals from the RDMA transport layer. Alternative embodiments may incorporate additional failure conditions such as repeated packet retries or abnormal latency spikes. This step ensures that a GID index change affecting an RC queue pair is identified promptly, triggering the recovery sequence.

The connectivity analysis module 550 queries 1020 the probe mesh to determine which NICs are functioning and their current GID indices. The probe mesh uses UD queue pairs bound to updated address handles to provide accurate liveness status and index information. In one embodiment, the query may request real-time probe results, while in another embodiment it may retrieve the latest stored probe data from monitoring logs. This step integrates UD-based health checks with RC-based data flows, allowing the recovery process to replace outdated indices with the correct ones.

The host 110 reconfigures 1030 RC queue pairs to use the new GID index obtained from the probe mesh. This may involve destroying the old queue pair object and recreating it with the correct index, or updating the queue pair attributes in place if supported by the RDMA stack. In various embodiments, reconfiguration commands may be issued via RDMA verbs, NIC driver APIs, or orchestration-level RDMA management tools. By ensuring the RC queue pair is bound to the correct GID index, reliable packet delivery is re-established.

The host 110 restores 1040 data packet transmission via new paths configured with the updated GID index. In one embodiment, restoration includes initiating new connections to remote NICs and resuming workload-level communications. In alternative embodiments, the module may also verify link quality with test transmissions before resuming production traffic. This final step completes the recovery process, ensuring that RC queue pairs operate reliably and workloads continue without experiencing prolonged downtime.

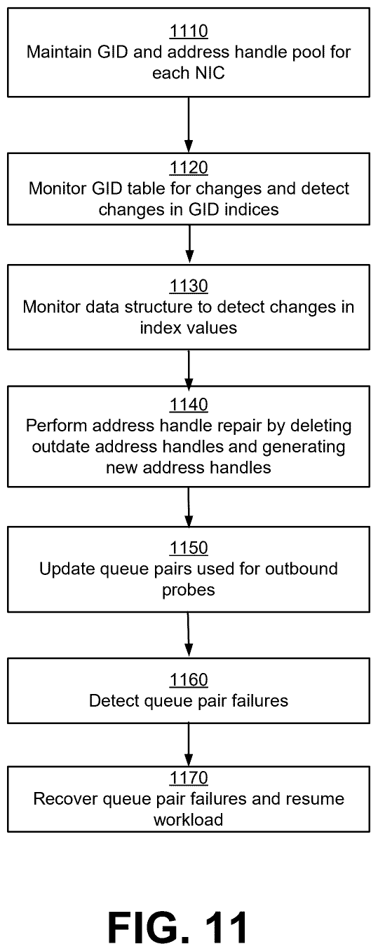

FIG. 11 shows a flowchart illustrating the overall process of recovery in view of GID changes, according to an embodiment. The process illustrates a complete detection, repair, and recovery sequence that enables continuous RDMA workload operation even when GID indices change mid-run. The system maintains accurate per-NIC mapping of global identifiers and address handles, performs change detection and repair, and probe-driven connectivity checks and RC queue pair recovery. The system ensures that both UD and RC communications remain functional.

The GID table watcher module 230 maintains 1110 the GID table for each NIC in the host. Each NIC stores multiple GIDs, each with an associated GID index, allowing the NIC to support multiple network identities, VLANs, or subnets. The GID table watcher module 230 also ensures that each NIC's address handle pool is maintained in NIC memory, with each handle containing a source GID index and destination GID to enable correct packet routing through UD queue pairs.

The GID table watcher module 230 monitors 1120 the GID table for changes in GID indices. This monitoring may be implemented as a periodic scanning thread running at a configurable interval, or as a continuous real-time watcher listening for driver-level notifications. The goal is to promptly detect changes caused by link flaps, VLAN/subnet reconfigurations, NIC resets, or other network events.

The GID table watcher module 230 monitors 1130 the mapping data structure to detect changes in index values. Upon identifying a change, the GID table watcher module 230 determines whether the modification affects a particular NIC and passes this information to the repair subsystem. The GID table watcher module 230 may perform differential comparisons, maintain historical snapshots, or use checksum validation to perform detection.

The address handle repair module 235 performs 1140 address handle repair by deleting outdated address handles that reference the previous GID index and generating new handles using the updated index and correct destination GID. The address handle repair module 235 accesses the specific NIC's address handle pool and updates only the affected handles, preventing packet routing errors while minimizing repair overhead.

The address handle repair module 235 updates 1150 the UD queue pairs used for outbound probes so that they reference the new address handles. This ensures that probe transmissions will use valid routing information immediately after a GID index change, maintaining accurate health monitoring and avoiding false failover triggers.

The probe mesh module 240 detects 1160 queue pair failures by evaluating outbound probe results and monitoring RC queue pair communications. Failures may be identified by timeouts, lack of responses, or error signals from the RDMA transport layer, indicating that the outdated GID index is preventing successful communication.

The probe mesh module 240 recovers 1170 queue pair failures and resumes workload operation by using probe mesh results to determine which NICs are alive and their current GID indices. The RC queue pairs are then reconfigured with the updated GID index to restore reliable data transfer. Once both UD and RC paths are validated, the workload continues without interruption, even if GID indices change multiple times during execution.

### Additional Embodiments

In one embodiment, the system integrates multiple resilience mechanisms to provide comprehensive fault tolerance for RDMA workloads. The system coordinates UD queue pair resilience and RC queue pair resilience to ensure uninterrupted communication regardless of the type of network failure encountered. The UD queue pair resilience mechanism operates via the address handle repair module, which updates the NIC's address handle pool immediately upon detection of a GID index change by the GID table watcher module. This update binds outbound probes to valid routing information, maintaining accurate health monitoring and enabling the probe mesh to reliably assess NIC and link liveness. The RC queue pair resilience mechanism operates through a failover and reconfiguration process, wherein failures detected via timeouts, error signals, or probe mesh results trigger reconfiguration of RC queue pairs to use a current GID index, restoring reliable data path operation without manual intervention.

In various embodiments, the integration allows the system to handle both link failures without GID index change and link failures with GID index change. In the case of link failures without index change, the prior art method detects failures and recovers connectivity without modifying address handles, relying on direct reconnection or alternate path selection. In the case of link failures accompanied by a GID index change, the system extends recovery capabilities by incorporating address handle repair for UD queue pairs and corresponding reconfiguration for RC queue pairs, ensuring both probe traffic and workload data traffic operate with updated identifiers.

Optionally, this embodiment may include logic for handling changes to the GID value itself, not just GID index changes. In such embodiments, the GID table watcher detects both identifier value changes and index changes, and the address handle repair module regenerates address handles with updated source and destination GID values. The RC queue pair reconfiguration process likewise updates queue pairs to operate with the new GID values, preserving both health-check accuracy and data transmission integrity across the RDMA fabric. This optional capability provides an additional layer of robustness against deeper network reconfiguration events or subnet manager actions that remap GID values entirely.

In one embodiment, the system includes an operational logging and metrics process implemented through the metrics and logging module 350 of the GID table watcher module 230. The overall functionality of this process is to capture, store, and report operational events and performance data for ongoing monitoring and diagnostics. The metrics and logging module 350 records each detected GID index change event, including the timestamp, the NIC affected, the old index value, and the new index value. It also logs repair actions performed by the address handle repair module 235, detailing the number of address handles deleted, the number created with the updated GID index, and the duration of the repair operation.

The system may record probe results generated by the probe mesh module 240, such as liveness status, latency measurements, and packet loss rates for each NIC and network link. Recovery outcomes for RC queue pairs are likewise captured, including the trigger condition for recovery, the updated GID index applied, and the time to restore reliable data transmission. In various embodiments, the logging may be performed using structured log formats for integration with external monitoring systems. The system may perform logging by streaming events to a telemetry database for real-time analysis.

Alternative implementations may provide configurable verbosity levels so that only critical events are stored in resource-constrained environments, or may include correlation logic to relate GID index changes with subsequent repair and recovery actions. The recorded metrics can be displayed in dashboards for operators, exported to analytics tools for performance tuning, or used in automated alerting systems to detect recurring instability patterns. This embodiment ensures that all key aspects of detection, repair, probe validation, and recovery are traceable, enabling robust diagnostics and continuous improvement of the RDMA workload resilience mechanisms.

According to an embodiment, the RC queue pair recovery process operates in coordination with the UD probe mesh, ensuring that updated GID indices and active NIC information are provided seamlessly to RC queue pairs. This coordination allows workloads to continue without interruption even during recovery events. In some embodiments, RC queue pair recovery is automatically triggered in response to detected failure conditions, eliminating the need for manual reconfiguration and reducing downtime.

### Technical Improvements

The system provides improvements to RDMA-based networked computing environments by introducing automated, runtime mechanisms that detect and remediate changes to critical RDMA connection parameters, specifically GID index values without interrupting ongoing workloads. Conventional RDMA systems, including NCCL workloads, select a GID index at job start and operate without mechanisms to handle mid-run changes. When a GID index changes due to dynamic conditions, such as link flaps, interface resets, or VLAN/subnet modifications, existing systems fail to update associated routing structures, causing packet loss, probe failures, incorrect liveness determinations, and RC queue pair communication breakdowns.

The system as disclosed overcome these deficiencies by enabling automated, low-latency detection of GID index changes through a GID table watcher that monitors per-NIC GID tables via configurable periodic scans or real-time event-driven threads, reducing latency between a network change and detection from seconds or minutes to near real-time. The system further performs targeted address handle repair, upon detecting a change, the system identifies all affected address handles in a NIC's internal memory, deletes outdated entries, and generates new handles referencing the updated GID index. This ensures outbound RDMA packets, including health probes, are routed correctly, preventing false failure signals and unnecessary failover.

The system also provides coordinated UD and RC queue pair resilience by integrating updated address handle pools with UD queue pairs for continuous probe-based connectivity analysis and using probe mesh results to accurately reconfigure RC queue pairs mid-run. This maintains both unreliable probe traffic and reliable data traffic without manual intervention or job restart. The system expands the scope of fault tolerance to handle both link failures without GID index changes and link failures with GID index changes, and optionally accommodates changes to the GID value itself, extending resilience to deeper network reconfiguration events.

These improvements enhance how NICs manage connection parameters and memory-resident routing information at runtime. By dynamically repairing and re-binding connection objects within NIC memory, the system improves the reliability and efficiency of RDMA packet transmission and health monitoring in distributed computing systems. The techniques disclosed enhance RDMA network fabrics, resulting in improved network connectivity, reduced downtime, elimination of false failover events, and sustained workload execution across disruptive network events.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for communicating in a networked computing environment using remote direct memory access (RDMA), the method comprising:
maintaining, for a plurality of network interface cards (NICs), a mapping between identifiers and corresponding identifier index values in a data structure;
for each NIC in the plurality of NICs, maintaining a set of address handles, wherein each address handle includes a source identifier index and destination identifier index pair, wherein the NIC uses an address handle from an address handle pool to transmit data packets to one or more other NICs;
monitoring the data structure to detect changes to identifier index values;
detecting that a first identifier index assigned to a particular index has changed to a second identifier index;
in response to detecting that the first identifier index assigned to the particular index has changed to the second identifier index, identifying a NIC associated with the particular index;
updating the address handle pool corresponding to the identified NIC to use the second identifier index instead of the first identifier index for the particular index; and
transmitting data packets using the updated address handle pool from the NIC to one or more other NICs.

2. The method of claim 1, wherein the data structure is a GID (global identifier) table within each NIC, the GID table storing a plurality of GIDs and associated GID index values.

3. The method of claim 1, wherein the address handle pool for each NIC is stored in an internal memory of the NIC and includes routing information including a source identifier index and a destination identifier.

4. The method of claim 1, wherein monitoring the data structure comprises periodically scanning the data structure at a predetermined frequency to detect changes to identifier index values.

5. The method of claim 1, wherein monitoring the data structure comprises executing a thread configured to continuously analyze the data structure in real-time to detect identifier index changes.

6. The method of claim 1, wherein updating the address handle pool further comprises:
identifying one or more address handles in the address handle pool that reference the first identifier index;
deleting the one or more address handles identified; and
generating one or more new address handles that reference the second identifier index.

7. The method of claim 1, wherein the NIC transmits the data packets using unreliable datagram (UD) queue pairs for health checking and the updated address handle pool is used for UD queue pairs to maintain connectivity after identifier index changes.

8. The method of claim 1, wherein detecting a change to the identifier index comprises identifying a network event selected from a link flap, an interface reset, a VLAN (virtual local area network) reconfiguration, or a subnet reconfiguration.

9. The method of claim 1, wherein transmitting data packets using the updated address handle pool comprises transmitting outbound probe packets to verify connectivity to one or more remote NICs.

10. The method of claim 9, further comprising:
periodically transmitting outbound probe packets to detect liveness of NICs and links,
wherein a probe failure triggers at least one of:
switching to a different NIC, or
reconfiguring address handles.

11. The method of claim 1, wherein each NIC in the plurality of NICs communicates using reliable connection queue pairs for data transmission, and detecting that the first identifier index has changed further comprises identifying a failure in an RC queue pair due to use of an outdated identifier index.

12. The method of claim 11, wherein detecting the failure in the RC queue pair comprises monitoring for one or more error conditions selected from: transmission timeouts, absence of completion notifications, and reception of error signals from an RDMA transport layer.

13. The method of claim 11, wherein responsive to detecting the failure in the RC queue pair, the method further comprises querying a probe mesh implemented using UD queue pairs to determine which NICs are active and their current identifier indices.

14. The method of claim 13, wherein reconfiguring the RC queue pair comprises reading the data structure to obtain a current identifier index for the NIC and updating configuration of the RC queue pair to use the current identifier index.

15. A non-transitory computer readable storage medium storing instructions that when executed by one or more computer processors cause the one or more computer processors to perform steps for communicating in a networked computing environment using remote direct memory access (RDMA), the steps comprising:
maintaining, for a plurality of network interface cards (NICs), a mapping between identifiers and corresponding identifier index values in a data structure;
for each NIC in the plurality of NICs, maintaining a set of address handles, wherein each address handle includes a source identifier index and destination identifier index pair, wherein the NIC uses an address handle from an address handle pool to transmit data packets to one or more other NICs;
monitoring the data structure to detect changes to identifier index values;
detecting that a first identifier index assigned to a particular index has changed to a second identifier index;
in response to detecting that the first identifier index assigned to the particular index has changed to the second identifier index, identifying a NIC associated with the particular index;
updating the address handle pool corresponding to the identified NIC to use the second identifier index instead of the first identifier index for the particular index; and
transmitting data packets using the updated address handle pool from the NIC to one or more other NICs.

16. The non-transitory computer readable storage medium of claim 15, wherein updating the address handle pool further comprises:
identifying one or more address handles in the address handle pool that reference the first identifier index;
deleting the one or more address handles identified; and
generating one or more new address handles that reference the second identifier index.

17. The non-transitory computer readable storage medium of claim 15, wherein each NIC in the plurality of NICs communicates using reliable connection queue pairs for data transmission, and detecting that the first identifier index has changed further comprises identifying a failure in an RC queue pair due to use of an outdated identifier index.

18. A computer system comprising:
one or more computer processors; and
a non-transitory computer readable storage medium storing instructions that when executed by one or more computer processors cause the one or more computer processors to perform steps for communicating in a networked computing environment using remote direct memory access (RDMA), the steps comprising:
maintaining, for a plurality of network interface cards (NICs), a mapping between identifiers and corresponding identifier index values in a data structure;
for each NIC in the plurality of NICs, maintaining a set of address handles, wherein each address handle includes a source identifier index and destination identifier index pair, wherein the NIC uses an address handle from an address handle pool to transmit data packets to one or more other NICs;
monitoring the data structure to detect changes to identifier index values;
detecting that a first identifier index assigned to a particular index has changed to a second identifier index;
in response to detecting that the first identifier index assigned to the particular index has changed to the second identifier index, identifying a NIC associated with the particular index;
updating the address handle pool corresponding to the identified NIC to use the second identifier index instead of the first identifier index for the particular index; and
transmitting data packets using the updated address handle pool from the NIC to one or more other NICs.

19. The computer system of claim 18, wherein updating the address handle pool further comprises:
identifying one or more address handles in the address handle pool that reference the first identifier index;
deleting the one or more address handles identified; and
generating one or more new address handles that reference the second identifier index.

20. The computer system of claim 18, wherein each NIC in the plurality of NICs communicates using reliable connection queue pairs for data transmission, and detecting that the first identifier index has changed further comprises identifying a failure in an RC queue pair due to use of an outdated identifier index.
